(19) United States
(12) Patent Application Publication
(10) Pub. No.: US 2022/0161653 A1
(43) Pub. Date: May 26, 2022

(54) FRONT-AND-REAR-WHEEL DRIVE VEHICLE

(71) Applicant: JTEKT CORPORATION, Kariya-shi (JP)

(72) Inventor: Noriyuki Fujii, Hekinan-shi (JP)

(73) Assignee: JTEKT CORPORATION, Kariya-shi (JP)

(21) Appl. No.: 17/456,019

(22) Filed: Nov. 22, 2021

(30) Foreign Application Priority Data
Nov. 26, 2020 (JP) 2020-196053

(51) Int. Cl. B60K 17/35; B60K 17/22; B60K 17/356; B60K 17/354; B60K 17/02; B60K 17/16; B60K 1/00; F16H 37/08

(52) U.S. Cl. CPC B60K 17/35; B60K 17/22; B60K 17/356; B60K 17/354; F16H 2702/02; B60K 17/16; B60K 1/00; F16H 37/082; B60K 17/02

(57) ABSTRACT

A front-and-rear-wheel drive vehicle includes a front wheel-side driveshaft, a rear wheel-side driveshaft, and a driving force distribution device that distributes the driving force of a driving source to the front wheel-side driveshaft and the rear wheel-side driveshaft. The driving force distribution device includes a first rotating member, a second rotating member, an annular driving force transmission medium that transmits the driving force from the first rotating member to the second rotating member, and a motor driving force-rotated member that is rotated by the driving force of an electric motor. The motor driving force-rotated member is passed inside the driving force transmission medium, between the first rotating member and the second rotating member.

### CROSS-REFERENCE TO RELATED APPLICATION

This application claims priority to Japanese Patent Application No. 2020-196053 filed on Nov. 26, 2020, incorporated herein by reference in its entirety.

### BACKGROUND

### 1. Technical Field

The disclosure relates to a front-and-rear-wheel drive vehicle that can drive its front wheels and rear wheels.

### 2. Description of Related Art

Among known front-and-rear-wheel drive vehicles that can drive their front wheels and rear wheels is the hybrid electric vehicle described in Japanese Unexamined Patent Application Publication No. 2020-29189. This hybrid electric vehicle has a longitudinally mounted engine, a first motor, and a second motor as driving sources, with the first motor and the second motor disposed on the rear side of the engine in a vehicle front-rear direction, side by side in an axial direction. An engine torque output by the engine and a first motor torque output by the first motor are transmitted to the rear wheels through an automatic transmission and a rear propeller shaft. A second motor torque output by the second motor is transmitted to the front wheels through a chain-driven speed reduction mechanism having a pair of sprockets and a chain, and a front propeller shaft.

### SUMMARY

Recently, the number of vehicles that have an electric motor as a driving source has been on the rise, and electric motors have been increasingly widely used as a driving source also in front-and-rear-wheel drive vehicles that can drive their front wheels and rear wheels. Such front-and-rear-wheel drive vehicles having an electric motor as a driving source are required to distribute driving force to the front wheels and the rear wheels while reducing the speed of rotation of an output rotating shaft of the electric motor. In these vehicles, compared with vehicles that drive only their front wheels or rear wheels, this complicates the configuration of a driving force distribution device that distributes the driving force of the driving source toward the front wheels and toward the rear wheels, causing an increase in both the size and weight of the driving force distribution device. An increase in the size of the driving force distribution device restricts the vehicle cabin space, while an increase in the weight thereof leads to degraded travel performance and increased energy consumption of the vehicle.

In a front-and-rear-wheel drive vehicle having an electric motor as a driving source, the disclosure can reduce the size and weight of a driving force distribution device that can distribute the driving force of the driving source toward the front wheels and toward the rear wheels.

An aspect of the disclosure is a front-and-rear-wheel drive vehicle. The front-and-rear-wheel drive vehicle includes at least an electric motor as a driving source and can drive its front wheels and rear wheels. The front-and-rear-wheel drive vehicle includes: a front wheel-side driveshaft configured to transmit a driving force toward the front wheels; a rear wheel-side driveshaft configured to transmit the driving force toward the rear wheels; and a driving force distribution device configured to distribute the driving force of the driving source to the front wheel-side driveshaft and the rear wheel-side driveshaft. The driving force distribution device includes: a first rotating member; a second rotating member configured to rotate around a rotational axis parallel to a rotational axis of the first rotating member; an annular driving force transmission medium configured to transmit the driving force from the first rotating member to the second rotating member; and a motor driving force-rotated member configured to be rotated by the driving force of the electric motor. The motor driving force-rotated member is passed inside the driving force transmission medium, between the first rotating member and the second rotating member.

In a front-and-rear-wheel drive vehicle having an electric motor as a driving source, this configuration can reduce the size and weight of the driving force distribution device that can distribute the driving force of the driving source toward the front wheels and toward the rear wheels.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic con figuration diagram showing the configuration of a driving system of a front-and-rear wheel drive vehicle according to a first embodiment of the disclosure;

FIG. 2 is a configuration diagram showing positional relationships among a chain mechanism, an electric motor, an input gear, an idle gear, and an input-side gear and a coupling shaft of a double gear according to the first embodiment;

FIG. 3 is a perspective view showing the chain mechanism according to the first embodiment along with a part of the coupling shaft of the double gear;

FIG. 4 is a schematic configuration diagram showing the configuration of a driving system of a front-and-rear-wheel drive vehicle according to a modified example of the first embodiment;

FIG. 5 is a schematic configuration diagram showing the configuration of a driving system of a front-and-rear-wheel drive vehicle according to a second embodiment;

FIG. 6 is a configuration diagram showing positional relationships among an electric motor, an input gear, an input-side gear and a coupling shaft of a double gear, and a chain mechanism according to the second embodiment;

FIG. 7 is a schematic configuration diagram showing the configuration of a driving system of a front-and-rear-wheel drive vehicle according to Modified Example 1 of the second embodiment;

FIG. 8 is a schematic configuration diagram showing the configuration of a driving system of a front-and-rear-wheel drive vehicle according to Modified Example 2 of the second embodiment;

FIG. 9 is a schematic configuration diagram showing the configuration of a driving system of a front-and-rear-wheel drive vehicle according to a third embodiment;

FIG. 10 is a schematic configuration diagram showing the configuration of a driving system of a front-and-rear-wheel drive vehicle according to Modified Example 1 of the third embodiment;

FIG. 11 is a schematic configuration diagram showing the configuration of a driving system of a front-and-rear-wheel drive vehicle according to Modified Example 2 of the third embodiment;

FIG. 12 is a schematic configuration diagram showing the configuration of a driving system of a front-and-rear-wheel drive vehicle according to a fourth embodiment;

FIG. 13 is a schematic configuration diagram showing the configuration of a driving system of a front-and-rear-wheel drive vehicle according to a fifth embodiment; and

FIG. 14 is a configuration diagram showing positional relationships among an electric motor, an input gear, an idle gear, a coupling shaft of a double gear, and a gear mechanism according to the fifth embodiment.

### DETAILED DESCRIPTION OF EMBODIMENTS

### First Embodiment

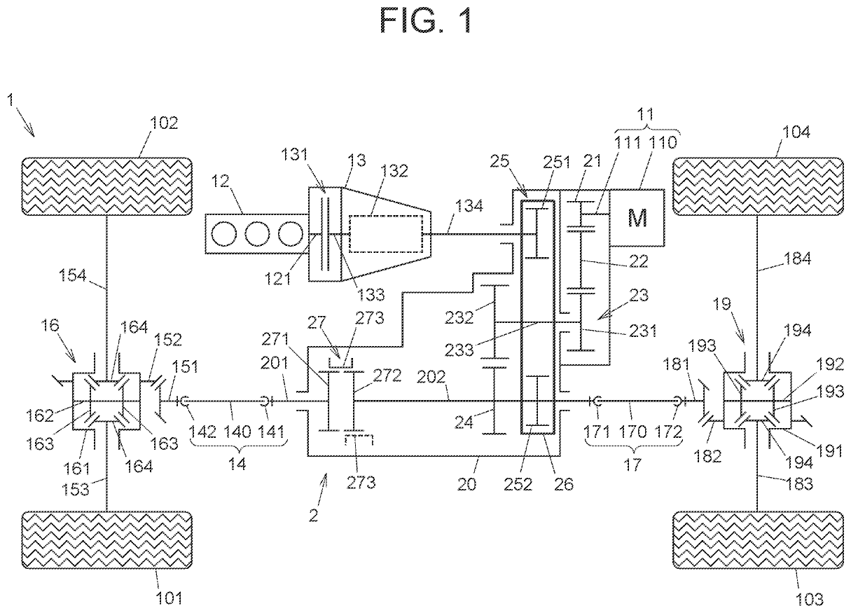

A first embodiment of the disclosure will be described with reference to FIG. 1 to FIG. 3. The embodiment described below is shown as a specific example suitable for implementing the disclosure. While some parts of the embodiment specifically illustrate various technical items that are technically preferable, the technical scope of the disclosure is not limited to such specific aspects.

FIG. 1 is a schematic configuration diagram showing the configuration of a driving system of a front-and-rear-wheel drive vehicle according to the first embodiment of the disclosure. This front-and-rear-wheel drive vehicle 1 has an electric motor 11 and an engine 12 as driving sources, and includes a driving force distribution device 2 that can distribute the driving force of these driving sources toward front wheels 101, 102 and toward rear wheels 103, 104. In the following description, a “front side” refers to a front side in a vehicle front-rear direction of the front-and-rear-wheel drive vehicle 1, and a “rear side” refers to a rear side in the vehicle front-rear direction of the front-and-rear-wheel drive vehicle 1.

The driving force distribution device 2 can switch between a four-wheel drive state in which the driving fore is distributed to the left and right front wheels 101, 102 and the rear wheels 103, 104, and a two-wheel drive state in which the driving force is distributed to only the rear wheels 103, 104. At least part of the driving force distribution device 2 and the electric motor 11 are disposed on a lower side of a vehicle cabin (under a floor).

The electric motor 11 is a three-phase alternating-current motor, for example, and generates power by a current supplied from an inverter device (not shown) as well as functions as a power generator that generates regenerative electricity. The electric motor 11 has a main body 110 that has a stator and a rotor, and an output rotating shaft 111 that protrudes from the main body 110 and rotates integrally with the rotor. The main body 110 is mounted at a rear-side end of a housing 20 of the driving force distribution device 2. The driving force (torque) of the electric motor 11 is input from the output rotating shaft 111 into the driving force distribution device 2. A rotational axis of the output rotating shaft 111 is parallel to the vehicle front-rear direction.

The engine 12 is an internal combustion engine that generates power by combusting liquid fuel, such as gasoline, inside cylinders. Rotation output from the engine 12 is input from an output rotating shaft 134 of a transmission 13 into the driving force distribution device 2 after the speed of rotation is changed in the transmission 13. The transmission 13 includes a clutch 131 and a speed change mechanism 132, and the clutch 131 connects and disconnects a crankshaft 121 that is an output rotating shaft of the engine 12 and an input rotating shaft 133 of the speed change mechanism 132 to and from each other. The engine 12 and the transmission 13 are longitudinally mounted on the front side of the electric motor 11 and the driving force distribution device 2, and rotational axes of the crankshaft 121 and the output rotating shaft 134 of the transmission 13 are parallel to the vehicle front-rear direction.

As a configuration for transmitting the driving force from the driving force distribution device 2 to the left and right front wheels 101, 102, the front-and-rear-wheel drive vehicle 1 has a front propeller shaft 14 as a front wheel-side driveshaft, a pinion gear shaft 151 coupled at a front end of the front propeller shaft 14, a ring gear 152 meshing with the pinion gear shaft 151, a front differential 16 having a differential case 161 that rotates integrally with the ring gear 152, and left and right driveshafts 153, 154.

The front propeller shaft 14 extends in the vehicle front-rear direction and transmits the driving force toward the front wheels 101, 102. The front propeller shaft 14 has a cylindrical or columnar shaft part 140 and joints 141, 142, such as cross joints, that are provided at rear-side and front-side ends of the shaft part 140. The pinion gear shaft 151 is swingably coupled to the shaft part 140 by the joint 142. The front differential 16 has the differential case 161, a pinion pin 162 that rotates integrally with the differential case 161, a plurality of pinion gears 163 that is rotatably supported by the pinion pin 162, and a pair of side gears 164 that meshes with the pinion gears 163. The left and right driveshafts 153, 154 are respectively coupled to the pair of side gears 164 so as to be unable to rotate relatively to the side gears 164.

As a configuration for transmitting the driving force from the driving force distribution device 2 to the left and right rear wheels 103, 104, the front-and-rear-wheel drive vehicle 1 has a rear propeller shaft 17 as a rear wheel-side driveshaft, a pinion gear shaft 181 coupled at a rear end of the rear propeller shaft 17, a ring gear 182 meshing with the pinion gear shaft 181, a rear differential 19 having a differential case 191 that rotates integrally with the ring gear 182, and left and right driveshafts 183, 184.

The rear propeller shaft 17 extends in the vehicle front-rear direction and transmits the driving force toward the rear wheels 103, 104. The rear propeller shaft 17 has a cylindrical or columnar shaft part 170 and joints 171, 172 that are provided at front-side and rear-side ends of the shaft part 170. The pinion gear shaft 181 is swingably coupled to the shaft part 170 by the joint 172. The rear differential 19 has the differential case 191, a pinion pin 192 that rotates integrally with the differential case 191, a plurality of pinion gears 193 that is rotatably supported by the pinion pin 192, and a pair of side gears 194 that meshes with the pinion gears 193. The left and right driveshafts 183, 184 are respectively coupled to the pair of side gears 194 so as to be unable to rotate relatively to the side gears 194.

The driving force distribution device 2 can distribute the driving force of the electric motor 11 and the driving force of the engine 12, of which the speed has been changed in the transmission 13, to the front propeller shaft 14 and the rear propeller shaft 17. The driving force distribution device 2 has a front wheel-side output rotating shaft 201 and a rear wheel-side output rotating shaft 202 on the same axis. The shaft part 140 of the front propeller shaft 14 is swingably coupled to the front wheel-side output rotating shaft 201 by the joint 141. The shaft part 170 of the rear propeller shaft 17 is swingably coupled to the rear wheel-side output rotating shaft 202 by the joint 171. In the following, the configuration of the driving force distribution device 2 will be described in detail.

The driving force distribution device 2 includes: an input gear 21 fixed on the output rotating shaft 111 of the electric motor 11; an idle gear 22 meshing with the input gear 21; a double gear 23 having an input-side gear 231 and an output-side gear 232 coupled together by a coupling shaft 233; and an output gear 24 fixed on the rear wheel-side output rotating shaft 202. The coupling shaft 233 of the double gear 23 couples the input-side gear 231 and the output-side gear 232 together such that the input-side gear 231 and the output-side gear 232 rotate integrally on the same rotational axis. The input-side gear 231 meshes with the idle gear 22 and the output-side gear 232 meshes with the output gear 24.

The driving force distribution device 2 further includes a first sprocket 251 fixed on the output rotating shaft 134 of the transmission 13, a second sprocket 252 fixed on the rear wheel-side output rotating shaft 202, and an annular chain 26 that is wrapped around the first sprocket 251 and the second sprocket 252 and rotates circularly. The first sprocket 251 is one aspect of the first rotating member of the disclosure, and the second sprocket 252 is one aspect of the second rotating member of the disclosure. The chain 26 is made of metal and is one aspect of the driving force transmission medium and the endless band-shaped body of the disclosure that transmit the driving force of the driving source from the first rotating member (first sprocket 251) to the second rotating member (second sprocket 252). The endless band-shaped body is not limited to the chain 26; for example, a resin belt may instead be used.

The driving force distribution device 2 further includes a positive clutch 27 that connects and disconnects the front wheel-side output rotating shaft 201 and the rear wheel-side output rotating shaft 202 to and from each other. The positive clutch 27 has a first disc 271 that rotates integrally with the front wheel-side output rotating shaft 201, a second disc 272 that rotates integrally with the rear wheel-side output rotating shaft 202, and a cylindrical sleeve 273 that moves in an axial direction relatively to the first disc 271 and the second disc 272, and the positive clutch 27 is disposed on the same axis as the second sprocket 252. The first disc 271 and the second disc 272 have external teeth that mesh with internal teeth of the sleeve 273.

The sleeve 273 is moved by the power of an actuator (not shown) between a coupling position in which the sleeve 273 couples the first disc 271 and the second disc 272 together so as to be unable to rotate relatively to each other, and an uncoupling position in which the sleeve 273 allows the first disc 271 and the second disc 272 to rotate relatively to each other. In a coupled state in which the sleeve 273 is in the coupling position, a differential between the front wheel-side output rotating shaft 201 and the rear wheel-side output rotating shaft 202 is restricted, and the front-and-rear-wheel drive vehicle 1 assumes a four-wheel drive state. On the other hand, in an uncoupled state in which the sleeve 273 is in the uncoupling position, a differential between the front wheel-side output rotating shaft 201 and the rear wheel-side output rotating shaft 202 is not restricted, and the front-and-rear-wheel drive vehicle 1 assumes a two-wheel drive state.

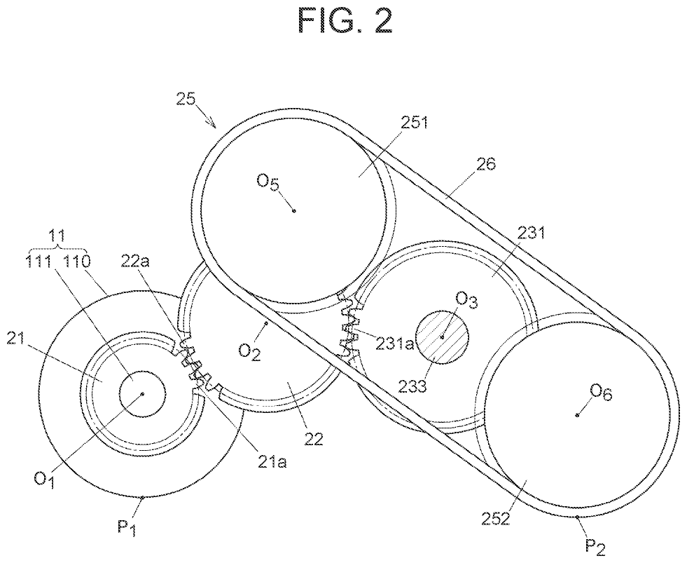

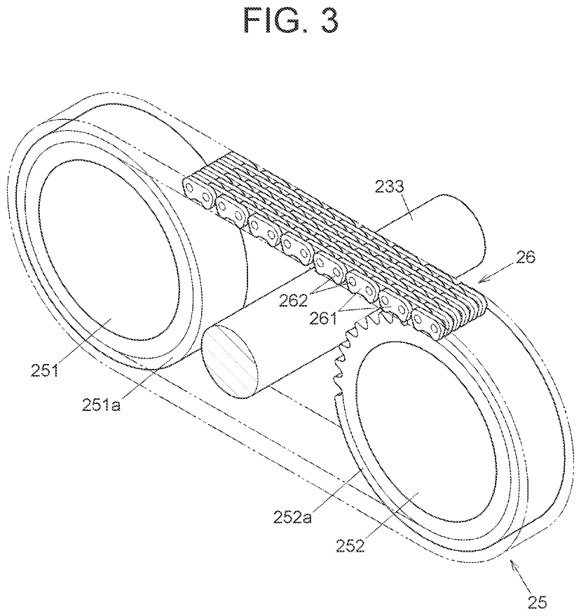

FIG. 2 is a configuration diagram showing positional relationships among a chain mechanism 25 composed of the first and second sprockets 251, 252 and the chain 26, the electric motor 11, the input gear 21, the idle gear 22, and the input-side gear 231 and the coupling shaft 233 of the double gear 23. In FIG. 2, the lower side of the drawing corresponds to a lower side in a vertical direction, and the upper side of the drawing corresponds to an upper side in the vertical direction. FIG. 3 is a perspective view showing the chain mechanism 25 along with a part of the coupling shaft 233 of the double gear 23.

The idle gear 22 and the double gear 23 are rotatably supported on the housing 20 by bearings (not shown). Gear teeth 22a of the idle gear 22 mesh with gear teeth 21a of the input gear 21 and gear teeth 231a of the input-side gear 231. The electric motor 11 is disposed such that a rotational axis O₁ of the output rotating shaft 111 thereof is located on the lower side in the vertical direction relative to a rotational axis O₂ of the idle gear 22 and a rotational axis O₃ of the double gear 23. The torque generated by the electric motor 11 is amplified by the idle gear 22 and the double gear 23 and transmitted from the output gear 24 to the rear wheel-side output rotating shaft 202.

As shown in FIG. 3, the chain 26 is composed of a plurality of metal plates 261 and a plurality of pins 262 coupling the plates 261 together. The first and second sprockets 251, 252 have, at their outer circumferential ends, teeth 251a, 252a, respectively, that mesh with the chain 26. The driving force of the engine 12 input from the output rotating shaft 134 of the transmission 13 into the first sprocket 251 is transmitted to the second sprocket 252 by the chain 26 and transmitted from the second sprocket 252 to the rear wheel-side output rotating shaft 202. The pitch diameter of the first sprocket 251 and the pitch diameter of the second sprocket 252 are equal.

In the double gear 23, the input-side gear 231 is disposed on the rear side of the chain 26 and the output-side gear 232 is disposed on the front side of the chain 26, with the coupling shaft 233 passed inside the chain 26, between the first sprocket 251 and the second sprocket 252. The double gear 23 is one aspect of the compound gear of the disclosure. The coupling shaft 233 of the double gear 23 is a rotating member that is rotated by the driving force of the electric motor 11 between the first sprocket 251 and the second sprocket 252, and is one aspect of the motor driving force-rotated member of the disclosure.

As shown in FIG. 2, the first sprocket 251 is disposed such that a rotational axis O₅ thereof is located on the upper side in the vertical direction relative to a rotational axis O₆ of the second sprocket 252. The rotational axis O₁ of the output rotating shaft 111 of the electric motor 11, the rotational axis O₂ of the idle gear 22, and the rotational axis O₃ of the double gear 23 are located between the rotational axis O₅ of the first sprocket 251 and the rotational axis O₆ of the second sprocket 252 in the vertical direction. A lowermost point P₁ in the vertical direction of the electric motor 11 is located on the upper side in the vertical direction relative to a lowermost point P₂ in the vertical direction of the chain 26.

Only the driving force of the electric motor 11, or only the driving force of the engine 12, or both the driving force of the electric motor 11 and the driving force of the engine 12 are transmitted to the rear wheel-side output rotating shaft 202 according to vehicle information, such as a vehicle speed and an amount of depression of an accelerator pedal. When the front-and-rear-wheel drive vehicle 1 decelerates, the electric motor 11 generates regenerative electricity, and a battery (not shown) is charged with this regenerative electricity. When only the driving force of the electric motor 11 is transmitted to the rear wheel-side output rotating shaft 202 or when the electric motor 11 generates regenerative electricity, the clutch 131 uncouples the crankshaft 121 and the input rotating shaft 133 of the speed change mechanism 132 from each other.

When the four-wheel drive state is selected by, for example, the driver's switch operation, the sleeve 273 of the positive clutch 27 is moved to the coupling position by the actuator. Thus, the first disc 271 and the second disc 272 are coupled together so as to be unable to rotate relatively to each other, and part of the driving force transmitted to the rear wheel-side output rotating shaft 202 is transmitted to the front wheel-side output rotating shaft 201 through the positive clutch 27.

According to the first embodiment having been described above, the coupling shaft 233 of the double gear 23 is passed inside the chain 26, between the first sprocket 251 and the second sprocket 252. This arrangement can reduce the size and weight of the driving force distribution device 2 compared with, for example, disposing the coupling shaft 233 on the upper side or the lower side of the chain 26. Specifically, disposing the double gear 23 such that the coupling shaft 233 is located on the upper side of the chain 26 restricts the vehicle cabin space, while disposing the double gear 23 such that the coupling shaft 233 is located on the lower side of the chain 26 reduces the minimum ground clearance. With the coupling shaft 233 passed inside the chain 26, between the first sprocket 251 and the second sprocket 252, this embodiment makes it possible to densely dispose the members by making good use of the space inside the housing 20 and thereby reduce the size and weight of the driving force distribution device 2.

### Modified Example of First Embodiment

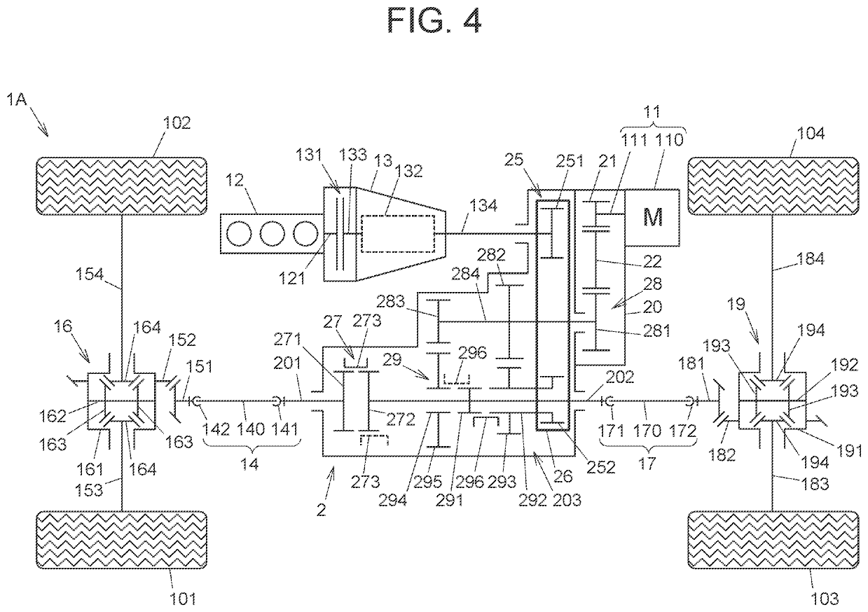

Next, a modified example of the first embodiment will be described with reference to FIG. 4. FIG. 4 is a schematic configuration diagram showing the configuration of a driving system of a front-and-rear-wheel drive vehicle 1A according to the modified example of the first embodiment.

In the first embodiment, the case has been described in which the speed reduction ratio from the output rotating shaft 111 of the electric motor 11 to the rear wheel-side output rotating shaft 202 (the number of times the output rotating shaft 111 rotates while the rear wheel-side output rotating shaft 202 rotates once) is fixed. In this modified example, the speed reduction ratio from the output rotating shaft 111 of the electric motor 11 to the rear wheel-side output rotating shaft 202 can be switched between two ratios. To achieve this, the driving force distribution device 2 in this modified example includes a speed change mechanism 203 having a triple gear 28 and a switching clutch 29, instead of the double gear 23.

The triple gear 28 has an input-side gear 281, a first output-side gear 282, a second output-side gear 283, and a coupling shaft 284. The coupling shaft 284 couples the input-side gear 281, the first output-side gear 282, and the second output-side gear 283 together such that these gears 281 to 283 rotate integrally on the same rotational axis. The input-side gear 281 is disposed on the rear side of the chain 26 and meshes with the idle gear 22. The first output-side gear 282 and the second output-side gear 283 are disposed on the front side of the chain 26. The pitch diameter of the first output-side gear 282 is larger than the pitch diameter of the second output-side gear 283.

The switching clutch 29 includes, as components: an output gear 291 fixed on the rear wheel-side output rotating shaft 202; a rear-side tubular body 292 disposed on the rear side of the output gear 291; a first transmission gear 293 fixed on the rear-side tubular body 292; a front-side tubular body 294 disposed on the front side of the output gear 291; a second transmission gear 295 fixed on the front-side tubular body 294; and a sleeve 296 disposed on an outer circumference of the output gear 291. The rear-side tubular body 292 and the front-side tubular body 294 have external teeth that mesh with internal teeth of the sleeve 296. The second sprocket 252 is fixed on the rear-side tubular body 292.

The rear wheel-side output rotating shaft 202 is passed through central portions of the rear-side tubular body 292 and the front-side tubular body 294, and these tubular bodies are supported by bearings on the same axis as the rear wheel-side output rotating shaft 202 so as to be able to rotate relatively to the rear wheel-side output rotating shaft 202. The rear wheel-side output rotating shaft 202 extends through the output gear 291. The sleeve 296 is moved by an actuator (not shown) in the axial direction between a first coupling position in which the sleeve 296 couples the output gear 291 and the rear-side tubular body 292 together so as to be unable to rotate relatively to each other, and a second coupling position in which the sleeve 296 couples the output gear 291 and the front-side tubular body 294 together so as to be unable to rotate relatively to each other. When the sleeve 296 is in the first coupling position, the output gear 291 and the front-side tubular body 294 can rotate relatively to each other, and when the sleeve 296 is in the second coupling position, the output gear 291 and the rear-side tubular body 292 can rotate relatively to each other. In FIG. 4, the sleeve 296 in the first coupling position is indicated by the solid line, and the sleeve 296 in the second coupling position is indicated by the broken line.

The driving force of the engine 12 input from the output rotating shaft 134 of the transmission 13 into the first sprocket 251 is transmitted to the second sprocket 252 and the rear-side tubular body 292 by the chain 26. The coupling shaft 284 of the triple gear 28 is passed inside the chain 26, between the first sprocket 251 and the second sprocket 252. The triple gear 28 is one aspect of the compound gear of the disclosure. The coupling shaft 284 of the triple gear 28 is a rotating member that is rotated by the driving force of the electric motor 11 between the first sprocket 251 and the second sprocket 252, and is one aspect of the motor driving force-rotated member of the disclosure.

The first transmission gear 293 meshes with the first output-side gear 282 of the triple gear 28, and the second transmission gear 295 meshes with the second output-side gear 283 of the triple gear 28. The pitch diameter of the second transmission gear 295 is larger than the pitch diameter of the first transmission gear 293. When the sleeve 296 is in the first coupling position, the driving force of the electric motor 11 transmitted to the triple gear 28 is transmitted from the first output-side gear 282 of the triple gear 28 to the rear-side tubular body 292 through the first transmission gear 293, and is further transmitted to the rear wheel-side output rotating shaft 202 through the sleeve 296 and the output gear 291. The driving force of the engine 12 transmitted to the second sprocket 252 is transmitted from the rear-side tubular body 292 to the rear wheel-side output rotating shaft 202 through the sleeve 296 and the output gear 291.

On the other hand, when the sleeve 296 is in the second coupling position, the driving force of the electric motor 11 transmitted to the triple gear 28 is transmitted from the second output-side gear 283 of the triple gear 28 to the front-side tubular body 294 through the second transmission gear 295, and is further transmitted to the rear wheel-side output rotating shaft 202 through the sleeve 296 and the output gear 291. The driving force of the entire 12 transmitted to the second sprocket 252 is transmitted to the rear wheel-side output rotating shaft 202 through the rear-side tubular body 292, the first transmission gear 293, the first output-side gear 282 and the second output-side gear 283 of the triple gear 28, the second transmission gear 295, the front-side tubular body 294, the sleeve 296, and the output gear 291.

In the modified example having been described above, the coupling shaft 284 of the triple gear 28 is passed inside the chain 26, between the first sprocket 251 and the second sprocket 252, which can reduce the size and weight of the driving force distribution device 2 as in the first embodiment. Further, from which of the first output side gear 282 and the second output-side gear 283 of the triple gear 28 the driving force of the electric motor 11 is transmitted to the front wheel-side output rotating shaft 201 and the rear wheel-side output rotating shaft 202 can be switched by controlling the switching clutch 29 according to, for example, the vehicle speed. Thus, the driving force of the electric motor 11 can be efficiently generated across a wide range of vehicle speed.

### Second Embodiment

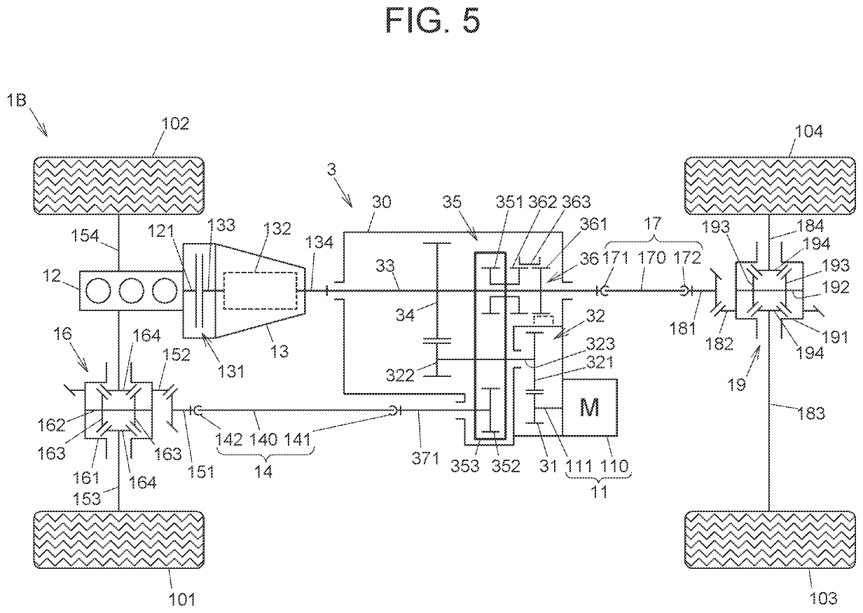

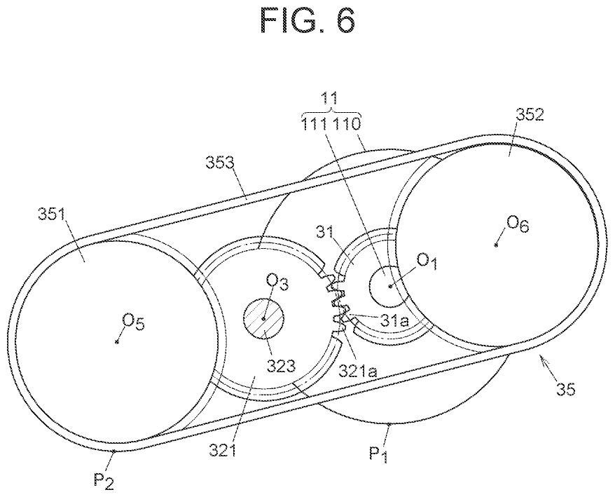

Next, a second embodiment of the disclosure will be described with reference to FIG. 5 and FIG. 6. FIG. 5 is a schematic configuration diagram showing the configuration of a driving system of a front-and-rear-wheel drive vehicle 1B according to the second embodiment. Members in FIG. 5 and FIG. 6 that are the same as those described in the first embodiment with reference to FIG. 1 will be denoted by the same reference signs as in FIG. 1 and overlapping description thereof will be omitted.

The front-and-rear-wheel drive vehicle 1B has a driving force distribution device 3, and the driving force distribution device 3 can distribute the driving force of the electric motor 11 and the engine 12 to the front propeller shaft 14 and the rear propeller shaft 17.

The driving force distribution device 3 includes: a housing 30; an input gear 31 fixed on the output rotating shaft 111 of the electric motor 11; a double gear 32 having an input-side gear 321 and an output-side gear 322 coupled together by a coupling shaft 323; a driveshaft 33 coupled to the output rotating shaft 134 of the transmission 13 so as to be unable to rotate relatively to the output rotating: shaft 134; an output gear 34 fixed on the driveshaft 33; a chain mechanism 35 having first and second sprockets 351, 352 and a chain 353; a positive clutch 36; and a front wheel-side output rotating shaft 371. The shaft part 170 of the rear propeller shaft 17 is swingably coupled at a rear end of the driveshaft 33 by the joint 171. The shaft part 140 of the front propeller shaft 14 is swingably coupled at a front end of the front wheel-side output rotating shaft 371 by the joint 141.

FIG. 6 is a configuration diagram showing positional relationships among the electric motor 11, the input gear 31, the input-side gear 321 and the coupling shaft 323 of the double gear 32, and the chain mechanism 35. Gear teeth 31a of the input gear 31 mesh with gear teeth 321a of the input-side gear 321 of the double gear 32. The output-side gear 322 of the double gear 32 meshes with the output gear 34. The coupling shaft 323 couples the input-side gear 321 and the output-side gear 322 together such that these gears 321, 322 rotate integrally on the same rotational axis. The lowermost point P₁ in the vertical direction of the electric motor 11 is located on the upper side in the vertical direction relative to a lowermost point P₂ in the vertical direction of the chain 353.

The double gear 32 is one aspect of the compound gear of the disclosure. The coupling shaft 323 of the double gear 32 is one aspect of the motor driving force-rotated member of the disclosure, and is passed inside the chain 353, between the first sprocket 351 and the second sprocket 352. The rotational axis O₁ of the output rotating shaft 111 of the electric motor 11 and a rotational axis O₃ of the double gear 32 are located between a rotational axis O₅ of the first sprocket 351 and a rotational axis O₆ of the second sprocket 352 in the vertical direction.

The pitch diameter of the input-side gear 321 is larger than the pitch diameter of the input gear 31. The pitch diameter of the output-side gear 322 is smaller than the pitch diameter of the input-side gear 321. The pitch diameter of the output gear 34 is larger than the pitch diameter of the output-side gear 322. The torque generated by the electric motor 11 is amplified by the input gear 31, the double gear 32, and the output gear 34 and transmitted to the driveshaft 33.

The first sprocket 351 has a hollow ring shape, with the driveshaft 33 passed through a central portion thereof. A rear-side end of the front wheel-side output rotating shaft 371 is fixed on the second sprocket 352. The chain 353 is an annular endless band-shaped body similar in configuration to the chain 26 of the first embodiment, and is wrapped around the first and second sprockets 351, 352 and rotates circularly.

The positive clutch 36 has a first disc 361 that rotates integrally with the driveshaft 33, a second disc 362 that rotates integrally with the first sprocket 351, and a sleeve 363 that moves in the axial direction relatively to the first disc 361 and the second disc 362, and the positive clutch 36 is disposed on the same axis as the first sprocket 351. The first disc 361 and the second disc 362 have external teeth that mesh with internal teeth of the sleeve 363.

The sleeve 363 is moved by the power of an actuator (not shown) between a coupling position in which the sleeve 363 couples the first disc 361 and the second disc 362 together so as to be unable to rotate relatively to each other, and an uncoupling position in which the sleeve 363 allows the first disc 361 and the second disc 362 to rotate relatively to each other. In FIG. 5, the sleeve 363 in the coupling position is indicated by the solid line, and the sleeve 363 in the uncoupling position is indicated by the broken line. Like the first sprocket 351, the second disc 362 has a hollow ring shape, with the driveshaft 33 passed through a central portion thereof.

The driving force of the electric motor 11 and the engine 12 is transmitted to the rear wheels 103, 104 through the driveshaft 33 and the rear propeller shaft 17. When the sleeve 363 of the positive clutch 36 is in the coupling position, the driving force of the electric motor 11 and the engine 12 is transmitted from the driveshaft 33 to the second disc 362 through the first disc 361, and is further transmitted to the front wheel-side output rotating shaft 371 through the chain mechanism 35. Thus, a four-wheel drive state in which the front wheels 101, 102 and the rear wheels 103, 104 are driven is established. In this four-wheel drive state, a differential between the front wheel-side output rotating shaft 371 and the driveshaft 33 is restricted. On the other hand, when the sleeve 363 is in the uncoupling position, a two-wheel drive state in which the driving force is not transmitted from the first disc 361 to the second disc 362 and only the rear wheels 103, 104 are driven is established. In this two-wheel drive state, a differential between the front wheel-side output rotating shaft 371 and the driveshaft 33 is not restricted.

Also in the second embodiment having been described above, the coupling shaft 323 of the double gear 32 is passed inside the chain 353, between the first sprocket 351 and the second sprocket 352, which can reduce the size and weight of the driving force distribution device 3.

### Modified Example 1 of Second Embodiment

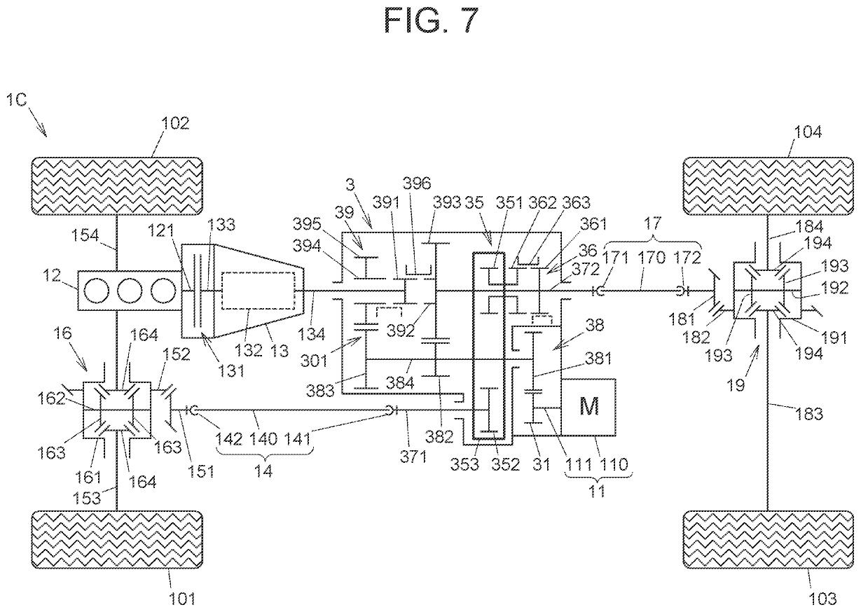

Next, Modified Example 1 of the second embodiment will be described with reference to FIG. 7. FIG. 7 is a schematic configuration diagram showing the configuration of a driving system of a front-and-rear-wheel drive vehicle 1C according to Modified Example 1 of the second embodiment.

In this modified example, the gear ratio from the output rotating shaft 134 of the transmission 13 to the rear propeller shaft 17 can be switched between two ratios. To achieve this, the driving force distribution device 3 in this modified example has a speed change mechanism 301 having a triple gear 38 and a switching clutch 39 instead of the double gear 32, and includes a rear wheel-side output rotating shaft 372 instead of the driveshaft 33.

The triple gear 38 has a rear-side gear 381, an intermediate gear 382, a front-side gear 383, and a coupling shaft 384. The coupling shaft 384 couples the rear-side gear 381, the intermediate gear 382, and the front-side gear 383 together such that these gears 381 to 383 rotate integrally on the same rotational axis. The rear-side gear 381 is disposed on the rear side of the chain 353 and meshes with the input gear 31. The intermediate gear 382 and the front-side gear 383 are disposed on the front side of the chain 353. The pitch diameter of the front-side gear 383 is larger than the pitch diameter of the intermediate gear 382.

The triple gear 38 is one aspect of the compound gear of the disclosure. The coupling shaft 384 of the triple gear 38 is one aspect of the motor driving force-rotated member of the disclosure, and is passed inside the chain 353, between the first sprocket 351 and the second sprocket 352.

The switching clutch 39 includes, as components: an intermediate rotating member 391 fixed on the output rotating shaft 134 of the transmission 13; a rear-side tubular body 392 disposed on the rear side of the intermediate rotating member 391; a first transmission gear 393 fixed on the rear-side tubular body 392; a front-side tubular body 394 disposed on the front side of the intermediate rotating member 391; a second transmission gear 395 fixed on the front-side tubular body 394; and a sleeve 396 disposed on an outer circumference of the intermediate rotating member 391. The pitch diameter of the first transmission gear 393 is larger than the pitch diameter of the second transmission gear 395.

The rear wheel-side output rotating shaft 372 is fixed on the first transmission gear 393. The rear wheel-side output rotating shaft 372 is passed through the first sprocket 351, and the shaft part 170 of the rear propeller shaft 17 is swingably coupled at a rear end of the rear wheel-side output rotating shaft 372 by the joint 171. The first disc 361 of the positive clutch 36 is fixed on the rear wheel-side output rotating shaft 372.

The rear-side tubular body 392 and the front-side tubular body 394 have external teeth that mesh with internal teeth of the sleeve 396. The sleeve 396 is moved by an actuator (not shown) in the axial direction between a first coupling position in which the sleeve 369 couples the intermediate rotating member 391 and the rear-side tubular body 392 together so as to be unable to rotate relatively to each other, and a second coupling position in which the sleeve 396 couples the intermediate rotating member 391 and the front-side tubular body 394 together so as to be unable to rotate relatively to each other. When the sleeve 396 is in the first coupling position, the intermediate rotating member 391 and the front-side tubular body 394 can rotate relatively to each other, and when the sleeve 396 is in the second coupling position, the intermediate rotating member 391 and the rear-side tubular body 392 can rotate relatively to each other. In FIG. 7, the sleeve 396 in the first coupling position is indicated by the solid line, and the sleeve 396 in the second coupling position is indicated by the broken line.

The first transmission gear 393 meshes with the intermediate gear 382 of the triple gear 38, and the second transmission gear 395 meshes with the front-side gear 383 of the triple gear 38. The driving force of the electric motor 11 transmitted to the triple gear 38 is transmitted from the intermediate gear 382 of the triple gear 38 to the rear wheel-side output rotating shaft 372 through the first transmission gear 393.

When the sleeve 396 is in the first coupling position, the driving force of the engine 12 transmitted to the intermediate rotating member 391 is transmitted to the rear-side tubular body 392 through the sleeve 396 and transmitted to the rear wheel-side output rotating shaft 372 through the first transmission gear 393. On the other hand, when the sleeve 396 is in the second coupling position, the driving force of the engine 12 transmitted to the intermediate rotating member 391 is transmitted to the front-side tubular body 394 through the sleeve 396, and is further transmitted to the rear wheel-side output rotating shaft 372 through the second transmission gear 395, the front-side gear 383 of the triple gear 38, the coupling shaft 384, the intermediate gear 382, and the first transmission gear 393.

When the pitch diameters of the second transmission gear 395, the front-side gear 383, the intermediate gear 382, and the first transmission gear 393 are denoted by PCD1, PCD2, PCD3, and PCD4, respectively, PCD4/PCD3 is larger than PCD2/PCD1. Therefore, when the sleeve 396 is in the second coupling position, the rotation of the output rotating shaft 134 of the transmission 13 is transmitted to the rear wheel-side output rotating shaft 372 after the speed of rotation is reduced.

Also in Modified Example 1 of the second embodiment, the coupling shaft 384 of the triple gear 38 is passed inside the chain 353, between the first sprocket 351 and the second sprocket 352, which can reduce the size and weight of the driving force distribution device 3.

### Modified Example 2 of Second Embodiment

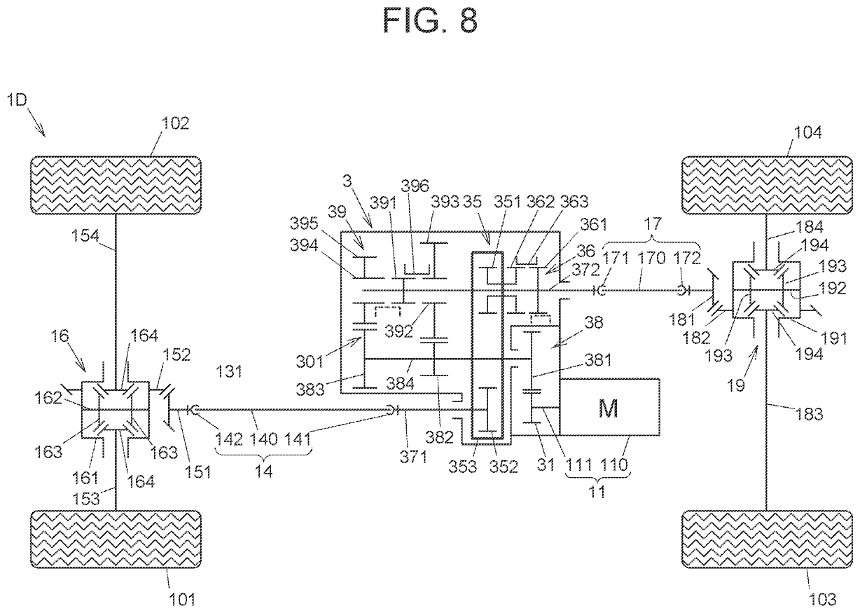

Next, Modified Example 2 of the second embodiment will be described with reference to FIG. 8. FIG. 8 is a schematic configuration diagram showing the configuration of a driving system of a front-and-rear-wheel drive vehicle 1D according to Modified Example 2 of the second embodiment.

The front-and-rear-wheel drive vehicle 1D according to this modified example has only the single electric motor 11 as a driving source and does not have the engine 12 and the transmission 13. The driving force distribution device 3 of the front-and-rear-wheel drive vehicle 1D can switch the speed reduction ratio from the output rotating shaft 111 of the electric motor 11 to the rear wheel-side output rotating shaft 372 between two ratios. The driving force distribution device 3 has the triple gear 38 and the switching clutch 39 as in Modified Example 1 described with reference to FIG. 7, but the rear wheel-side output rotating shaft 372 is fixed not on the first transmission gear 393 of the switching clutch 39 but on the intermediate rotating member 391.

When the sleeve 396 is in the first coupling position, the driving force of the electric motor 11 transmitted to the triple gear 38 is transmitted from the intermediate gear 382 to the first transmission gear 393 and the rear-side tubular body 392, and is further transmitted from the intermediate rotating member 391 to the rear wheel-side output rotating shaft 372 through the sleeve 396. When the sleeve 396 is in the second coupling position, the driving force of the electric motor 11 transmitted to the triple gear 38 is transmitted from the front-side 383 to the second transmission gear 395 and the front-side tubular body 394, and is further transmitted from the intermediate rotating member 391 to the rear wheel-side output rotating shaft 372 through the sleeve 396. In this modified example, the front-side gear 383 of the triple gear 38 corresponds to the input-side gear of the disclosure, and the intermediate gear 382 and the front-side gear 383 correspond to the output-side gears of the disclosure.

Also in Modified Example 2 of the second embodiment, as in Modified Example 1 of the second embodiment, the coupling shaft 384 of the triple gear 38 is passed inside the chain 353, between the first sprocket 351 and the second sprocket 352, which can reduce the size and weight of the driving force distribution device 3.

### Third Embodiment

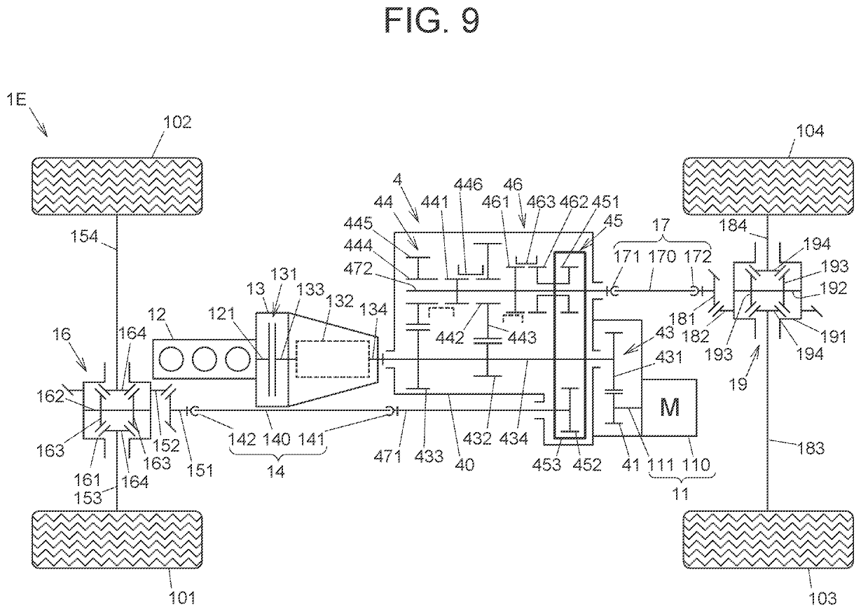

Next, a third embodiment of the disclosure will be described with reference to FIG. 9. FIG. 9 is a schematic configuration diagram showing the configuration of a driving system of a front-and-rear-wheel drive vehicle 1E according to the third embodiment. Members in FIG. 9 that are the same as those described in the first embodiment with reference to FIG. 1 will be denoted by the same reference signs as in FIG. 1 and overlapping description thereof will be omitted.

The front-and-rear-wheel drive vehicle 1E has a driving force distribution device 4, and the driving force distribution device 4 can distribute the driving force of the electric motor 11 and the engine 12 to the front propeller shaft 14 and the rear propeller shaft 17. Further, the driving force distribution device 4 can transmit the driving force to the front propeller shaft 14 and the rear propeller shaft 17 after changing the speed of rotation of the electric motor 11 and the speed of rotation of the output rotating shaft 134 of the transmission 13 between two speeds in driving force transmission paths to the front propeller shaft 14 and the rear propeller shaft 17.

The driving force distribution device 4 includes: a housing 40; an input gear 41 fixed on the output rotating shaft 111 of the electric motor 11; a triple gear 43; a switching clutch 44; a chain mechanism 45 having first and second sprockets 451, 452 and a chain 453; a positive clutch 46; a front wheel-side output rotating shaft 471; and a rear wheel-side output rotating shaft 472.

The chain 453 is an annular endless band-shaped body similar in configuration to the chain 26 of the first embodiment, and is wrapped around the first and second sprockets 451, 452 and rotates circularly. The shaft part 140 of the front propeller shaft 14 is swingably coupled to the front wheel-side output rotating shaft 471 by the joint 141. The shaft part 170 of the rear propeller shaft 17 is swingably coupled to the rear wheel-side output rotating shaft 472 by the joint 171.

The triple gear 43 has an input-side gear 431, a first output-side gear 432, a second output-side gear 433, and a coupling shaft 434. The coupling shaft 434 couples the input-side gear 431, the first output-side gear 432, and the second output-side gear 433 together such that these gears 431 to 433 rotate integrally on the same rotational axis. The input-side gear 431 is disposed on the rear side of the chain 453 and meshes with the input gear 41. The first output-side gear 432 and the second output-side gear 433 are disposed on the front side of the chain 453. The pitch diameter of the second output-side gear 433 is larger than the pitch diameter of the first output-side gear 432.

The output rotating shaft 134 of the transmission 13 is coupled at a front-side end of the coupling slut 434 so as to be unable to rotate relatively to the coupling shaft 434, and the driving force of the engine 12 of which the speed has been changed in the transmission 13 is directly transmitted to the triple gear 43. The triple gear 43 is one aspect of the compound gear of the disclosure. The coupling shaft 434 of the triple gear 43 is one aspect of the motor driving force-rotated member of the disclosure, and is passed inside the chain 453, between the first sprocket 451 and the second sprocket 452.

The switching clutch 44 includes, as components: an intermediate rotating member 441 through which the rear wheel-side output rotating shaft 472 is passed so as to be unable to rotate relatively to the intermediate rotating member 441; a rear-side tubular body 442 disposed on the rear side of the intermediate rotating member 441; a first transmission gear 443 fixed on the rear-side tubular body 442; a front-side tubular body 444 disposed on the front side of the intermediate rotating member 441; a second transmission gear 445 fixed on the front-side tubular body 444; and a sleeve 446 disposed on an outer circumference of the intermediate rotating member 441. The pitch diameter of the first transmission gear 443 is larger than the pitch diameter of the second transmission gear 445. The rear-side tubular body 442 and the front-side tubular body 444 have external teeth that mesh with internal teeth of the sleeve 446.

The first output-side gear 432 of the triple gear 43 meshes with the first transmission gear 443 of the switching clutch 44, and the second output-side gear 433 of the triple gear 43 meshes with the second transmission gear 445 of the switching clutch 44. The sleeve 446 is moved by an actuator (not shown) in the axial direction between a first coupling position in which the sleeve 446 couples the intermediate rotating member 441 and the rear-side tubular body 442 together so as to be unable to rotate relatively to each other, and a second coupling position in which the sleeve 446 couples the intermediate rotating member 441 and the front-side tubular body 444 together so as to be unable to rotate relatively to each other. When the sleeve 446 is in the first coupling position, compared with when the sleeve 446 is in the second coupling position, the torque of the triple gear 43 is amplified and the amplified torque is transmitted to the rear wheel-side output rotating shaft 472.

The positive clutch 46 has a first disc 461 that rotates integrally with the rear wheel-side output rotating shaft 472, a second disc 462 that rotates integrally with the first sprocket 451, and a sleeve 463 that moves in the axial direction relatively to the first disc 461 and the second disc 462, and the positive clutch 46 is disposed on the same axis as the first sprocket 451. The first disc 461 and the second disc 462 have external teeth that mesh with internal teeth of the sleeve 463.

The sleeve 463 is moved by the power of an actuator (not shown) between a coupling position in which the sleeve 463 couples the first disc 461 and the second disc 462 together so as to be unable to rotate relatively to each other, and an uncoupling position in which the sleeve 463 allows the first disc 461 and the second disc 462 to rotate relatively to each other. In FIG. 9, the sleeve 463 in the coupling position is indicated by the solid line, and the sleeve 463 in the uncoupling position is indicated by the broken line. Each of the second disc 462 and the first sprocket 451 has a hollow disc shape, with the rear wheel-side output rotating shaft 472 passed through a central portion thereof.

When the sleeve 463 is in the coupling position, part of the driving force transmitted to the rear wheel-side output rotating shaft 472 is transmitted to the front wheel-side output rotating shaft 471 through the positive clutch 46 and the chain mechanism 45, and the front-and-rear-wheel drive vehicle 1E assumes a four-wheel drive state. In this four-wheel drive state, a differential between the front wheel-side output rotating shaft 471 and the rear wheel-side output rotating shaft 472 is restricted. On the other hand, when the sleeve 463 is in the uncoupling position, the driving force transmission path to the front wheel-side output rotating shaft 471 is interrupted by the positive clutch 46, so that the front-and-rear wheel drive vehicle 1E assumes a two-wheel drive state. In this two-wheel drive state, a differential between the front wheel-side output rotating shaft 471 and the rear wheel-side output rotating shaft 472 is not restricted.

Also in the third embodiment having been described above, the coupling shaft 434 of the triple gear 43 is passed inside the chain 453, between the first sprocket 451 and the second sprocket 452, which can reduce the size and weight of the driving force distribution device 4.

### Modified Example 1 of Third Embodiment

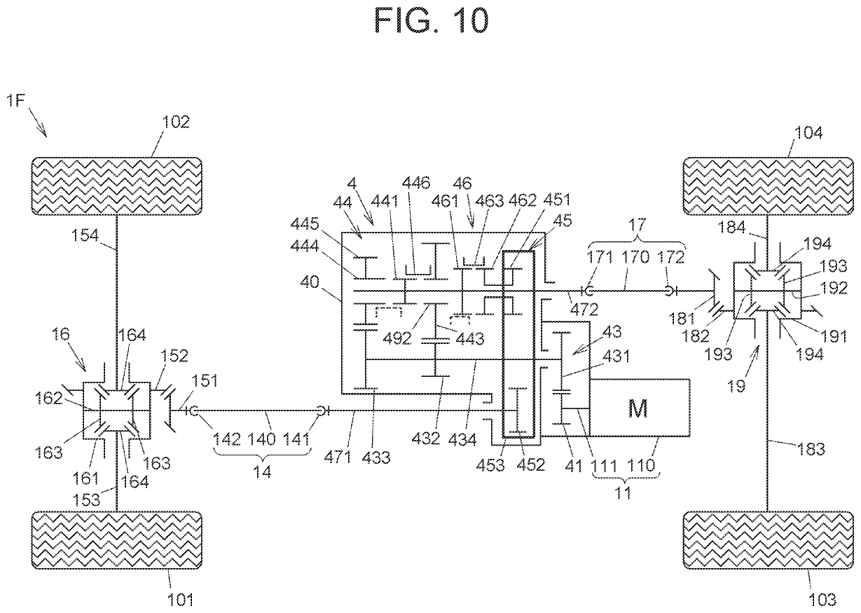

Next, Modified Example 1 of the third embodiment will be described with reference to FIG. 10. FIG. 10 is a schematic configuration diagram showing the configuration of a driving system of a front-and-rear-wheel drive vehicle 1F according to Modified Example 1 of the third embodiment.

In the third embodiment, the case in which the front-and-rear-wheel drive vehicle 1E has the electric motor 11 and the engine 12 as driving sources has been described. In this modified example, the front-and-rear-wheel drive vehicle 1F has only the single electric motor 11 as a driving source and does not have the engine 12 and the transmission 13. The configuration is otherwise the same as in the third embodiment. Thus, in this modified example, only the driving force of the electric motor 11 is transmitted to the triple gear 43 and transmitted from the triple gear 43 to the rear wheel-side output rotating shaft 472. The speed reduction ratio from the input gear 41 to the rear wheel-side output rotating shaft 472 can be switched between two ratios by the switching clutch 44.

As with the third embodiment, Modified Example 1 of the third embodiment can reduce the size and weight of the driving force distribution device 4. In addition, since the output rotating shaft 134 of the transmission 13 is not coupled at the front-side end of the coupling shaft 434 of the triple gear 43, the flexibility in disposing the driving force distribution device 4 in the vehicle layout is increased.

### Modified Example 2 of Third Embodiment

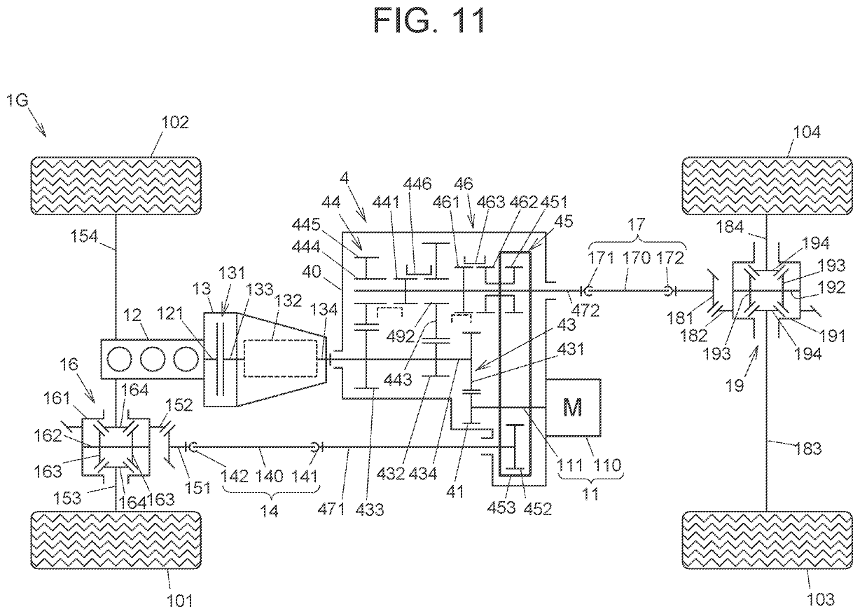

Next, Modified Example 2 of the third embodiment will be described with reference to FIG. 11. FIG. 11 is a schematic configuration diagram showing the configuration of a driving system of a front-and-rear-wheel drive vehicle 1G according to Modified Example 2 of the third embodiment.

In the third embodiment, the case has been described in which the input-side gear 431 of the triple gear 43 is disposed on the rear side of the chain 453, and the first output-side gear 432 and the second output-side gear 433 are disposed on the front side of the chain 453, with the coupling shaft 434 passed inside the chain 453, between the first sprocket 451 and the second sprocket 452. In this modified example, all the input-side gear 431, the first output-side gear 432, and the second output-side gear 433 are disposed on the front side of the chain 453.

In this modified example, the output rotating shaft 111 of the electric motor 11 is passed inside the chain 453, between the first sprocket 451 and the second sprocket 452. The input gear 41 is disposed on the front side of the chain 453, and the main body 110 of the electric motor 11 is disposed on the rear side of the chain 453. Thus, in this modified example, the output rotating shaft 111 of the electric motor 11 is the motor driving force-rotated member of the disclosure.

In this modified example, the output rotating shaft 111 of the electric motor 11 is passed inside the chain 453, between the first sprocket 451 and the second sprocket 452. This can reduce the size and weight of the driving force distribution device 4 compared with disposing the output rotating shaft 111 on the upper side or the lower side of the chain 453. The output rotating shaft 111 of the electric motor 11 may be a single member, or alternatively, the output rotating shaft 111 may be composed of a plurality of members coupled together in the axial direction along the rotational axis of the electric motor 1.

The driving force of the electric motor 11 may be directly transmitted to the triple gear 43 without involving the input gear 41 and the input-side gear 431. In this case, the electric motor 11 is disposed on the same axis as the triple gear 43, and the output rotating shaft 111 of the electric motor 11 is coupled to the coupling shaft 434. Further, the driving source may be formed by the single electric motor 11 as shown in FIG. 10 as Modified Example 1 of the third embodiment.

### Fourth Embodiment

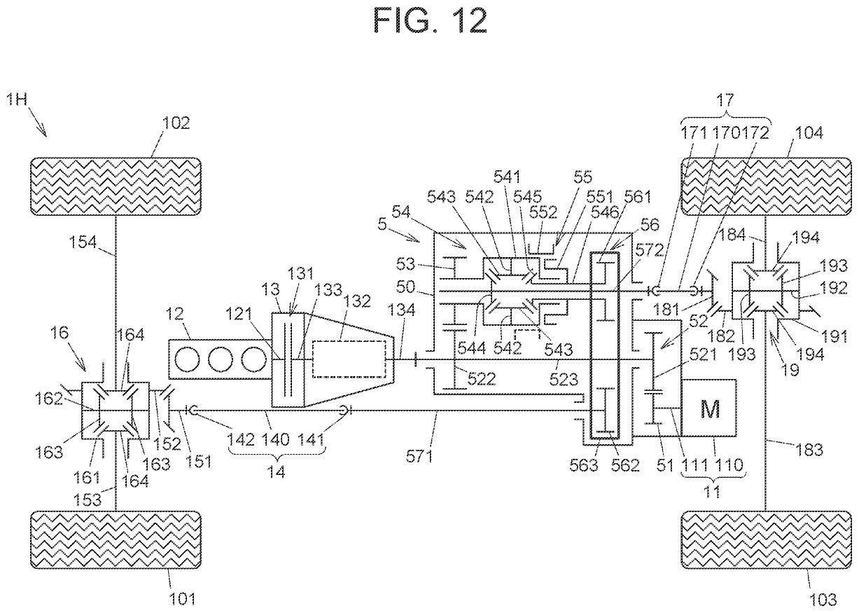

Next, a fourth embodiment of the disclosure will be described with reference to FIG. 12. FIG. 12 is a schematic configuration diagram showing the configuration of a driving system of a front-and-rear-wheel drive vehicle 1H according to the fourth embodiment. Members in FIG. 12 that are to same as those described in the first embodiment with reference to FIG. 1 will be denoted by the same reference signs as in FIG. 1 and overlapping description thereof will be omitted.

The front-and-rear-wheel drive vehicle 1H has a driving force distribution device 5, and the driving force distribution device 5 can distribute the driving force of the electric motor 11 and the engine 12 to the front propeller shaft 14 and the rear propeller shaft 17. The driving force distribution device 5 can switch between a four-wheel drive state in which a difference in the speed of rotation (differential) between the front propeller shaft 14 and the rear propeller shaft 17 is allowed, and a four-wheel drive state (rigid 4WD state) in which this difference in the speed of rotation is not allowed.

The driving force distribution device 5 includes: a housing 50; an input gear 51 fixed on the output rotating shaft 111 of the electric motor 11; a double gear 52 having an input-side gear 521 and an output-side gear 522 coupled together by a coupling shaft 523 so as to rotate integrally; a ring gear 53 meshing with the output-side gear 522; a differential gear mechanism 54 having a differential case 541 on which the ring gear 53 is mounted; a positive clutch 55; a chain mechanism 56 having first and second sprockets 561, 562 and a chain 563; a front wheel-side output rotating shaft 571; and a rear wheel-side output rotating shaft 572.

The chain 563 is an annular endless band-shaped body similar in configuration to the chain 26 of the first embodiment, and is wrapped around the first and second sprockets 561, 562 and rotates circularly. The shaft part 140 of the front propeller shaft 14 is swingably coupled to the front wheel-side output rotating shaft 571 by the joint 141. The shaft part 170 of the rear propeller shaft 17 is swingably coupled to the rear wheel-side output rotating shaft 572 by the joint 171.

In the double gear 52, the input-side gear 521 is disposed on the rear side of the chain 563, and the output-side gear 522 is disposed on the front side of the chain 563. The coupling shaft 523 is passed inside the chain 563, between the first sprocket 561 and the second sprocket 562. The input-side gear 521 meshes with the input gear 51, and the driving force of the electric motor 11 is transmitted from the input gear 51 to the double gear 52. The output rotating shaft 134 of the transmission 13 is coupled at a front-side end of the coupling shaft 523 so as to be unable to rotate relatively to the coupling shaft 523, and the driving force of the engine 12 of which the speed has been changed in the transmission 13 is transmitted to the double gear 52. The double gear 52 is one aspect of the compound gear of the disclosure, and the coupling shaft 523 is one aspect of the motor driving force-rotated member of the disclosure.

The differential gear mechanism 54 has the differential case 541, a pinion pin 542 fixed on the differential case 541, a plurality of pinion gears 543 rotatably supported on the pinion pin 542, first and second side gears 544, 545 meshing with the pinion gears 543, and a cylindrical coupling member 546 fixed on the second side gear 545, and the differential gear mechanism 54 is disposed on the same axis as the first sprocket 561. The first side gear 544 is disposed inside the differential case 541, on the front side of the pinion gears 543. The rear wheel-side output rotating shaft 572 is coupled to the first side gear 544 so as to be unable to rotate relatively to the first side gear 544.

The second side gear 545 is disposed inside the differential case 541, on the rear side of the pinion gears 543. The coupling member 546 is fixed at its front-side end on the second side gear 545 and at its rear-side end on the first sprocket 561, and thus couples the second side gear 545 and the first sprocket 561 together so as to be unable to rotate relatively to each other. The rear wheel-side output rotating shaft 572 is passed through a central portion of the second side gear 545, the coupling member 546, and a central portion of the first sprocket 561.

The driving force of the electric motor 11 and the engine 12 transmitted to the double gear 52 is transmitted from the ring gear 53 to the differential case 541, and is distributed from the first side gear 544 to the rear wheel-side output rotating shaft 572 and distributed from the second side gear 545 to the front wheel-side output rotating shaft 571 through the coupling member 546 and the chain mechanism 56.

The positive clutch 55 has a meshing member 551 fixed on an outer circumference of the coupling member 546, and a sleeve 552 disposed on an outer circumference of the differential case 541 and the meshing member 551, and the positive clutch 55 is disposed on the same axis as the first sprocket 561. The sleeve 552 is moved by the power of an actuator (not shown) in the axial direction between a coupling position in which the sleeve 552 couples the differential case 541 and the meshing member 551 together so as to be unable to rotate relatively to each other, and an uncoupling position in which the sleeve 552 allows the differential case 541 and the meshing member 551 to rotate relatively to each other.

In FIG. 12, the sleeve 552 in the coupling position is indicated by the solid line, and the sleeve 552 in the uncoupling position is indicated by the broken line. When the differential case 541 and the meshing member 551 are coupled together by the sleeve 552, the rotation of the differential case 541 and the rotation of the first and second side gears 544, 545 relative to each other is restricted, and thus a four-wheel drive state in which a difference in the speed of rotation between the front propeller shaft 14 and the rear propeller shaft 17 is not allowed is established. On the other hand, when the sleeve 552 moves to the uncoupling position, a four-wheel drive state in which a difference in the speed of rotation between the front propeller shaft 14 and the rear propeller shaft 17 is allowed is established.

Also in the fourth embodiment having been described above, the coupling shaft 523 of the double gear 52 is passed inside the chain 563, between the first sprocket 561 and the second sprocket 562, which can reduce the size and weight of the driving force distribution device 5. Since the differential gear mechanism 54 and the positive clutch 55 are disposed on the same axis as the first sprocket 561, the size of the driving force distribution device 5 can be reduced. Alternatively, the differential gear mechanism 54 and the positive clutch 55 may be disposed on the same axis as the second sprocket 562.

### Fifth Embodiment

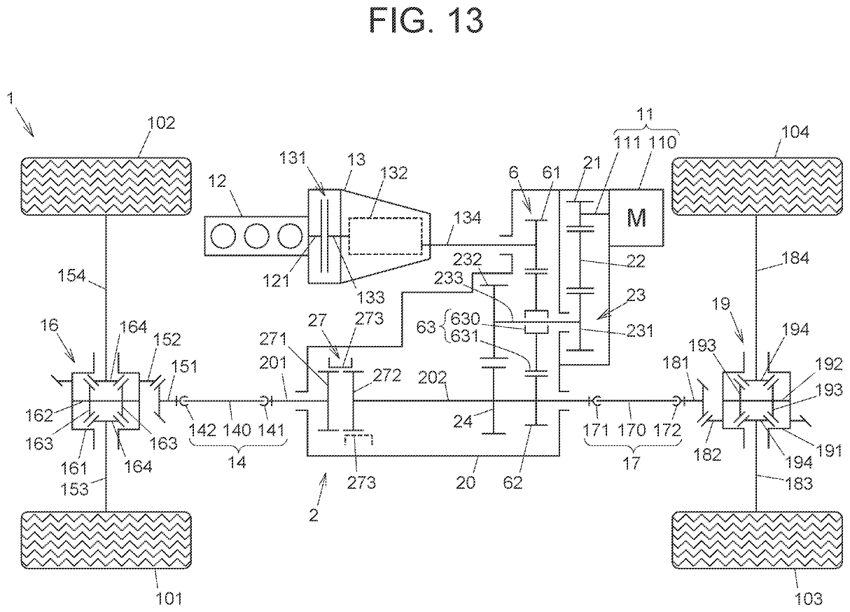

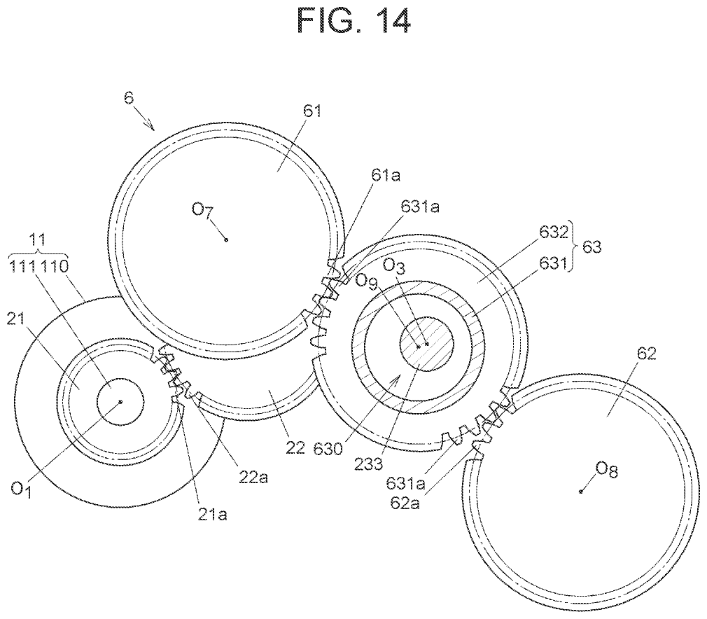

Next, a fifth embodiment of the disclosure will be described with reference to FIG. 13 and FIG. 14. In the fifth embodiment, the chain mechanism 25 in the front-and-rear-wheel drive vehicle 1 according to the first embodiment is replaced with a gear mechanism composed of a plurality of gears.

FIG. 13 is a schematic configuration diagram showing the configuration of a driving system of a front-and-rear-wheel drive vehicle 11 according to the fifth embodiment. Members in FIG. 13 and FIG. 14 that are the same as those described in the first embodiment with reference to FIG. 1 and FIG. 2 will be denoted by the same reference signs as in FIG. 1 and overlapping description thereof will be omitted.

A gear mechanism 6 has a drive gear 61 as a first rotating member, a driven gear 62 as a second rotating member, and an idle gear 63 as a driving force transmission medium that transmits the driving force of the engine 12 that is a driving source from the drive gear 61 to the driven gear 62. The drive gear 61 is fixed on the output rotating shaft 134 of the transmission 13 and rotates around a rotational axis O₇ shown in FIG. 14. The driven gear 62 is fixed on the rear wheel-side output rotating shaft 202 and rotates around a rotational axis O₈. The idle gear 63 has an annular shape with a through-hole 630 formed at a central portion and rotates around a rotational axis O₉. These rotational axes O₇, O₈, O₉, the rotational axis O₁ of the output rotating shaft 111 of the electric motor 11, and the rotational axis O₃ or the double gear 23 are parallel to one another and separated from one another.

The idle gear 63 has a cylindrical tube part 631 and a gear part 632 provided on an outer circumference of the tube part 631. A central portion of the tube part 631 forms the through-hole 630 along the rotational axis O₉, and the tube part 631 is rotatably supported on the housing 30 by a bearing (not shown). The gear part 632 of the idle gear 63 has, on its outer circumference, gear teeth 632a that mesh with gear teeth 61a of the drive gear 61 and gear teeth 62a of the driven gear 62.

The coupling shaft 233 of the double gear 23 is passed through the through-hole 630 of the idle gear 63. In this embodiment, as shown n FIG. 14, the idle gear 63 is eccentric relative to the double gear 23, and the rotational axis O₉ of the idle gear 63 and the rotational axis O₃ of the double gear 23 do not coincide with each other. However, the rotational axis O₉ of the idle gear 63 and the rotational axis O₃ of the double gear 23 may coincide with each other. As in the first embodiment, the coupling shaft 233 of the double gear 23 is one aspect of the motor driving force-rotated member of the disclosure, and is passed inside the idle gear 63, between the drive gear 61 and the driven gear 62, and rotated by the driving force of the electric motor 11. The components and the operation of the driving force distribution device 2 are otherwise the same as in the first embodiment.

In the fifth embodiment having been described above, the coupling shaft 233 of the double gear 23 is passed inside the idle gear 63 of the gear mechanism 6, between the drive gear 61 and the driven gear 62, which can reduce the size and weight of the driving force distribution device 2 as in the first embodiment. The chain mechanisms 35, 45, 56 shown in the second to fourth embodiments and the modified examples thereof may be replaced with the gear mechanism 6. Further, another gear may be added between the idle gear 63 having the through-hole 630 and at least one of the drive gear 61 and the driven gear 62.

### Note

While the disclosure has been described above based on the first to fifth embodiments and the modified examples, these embodiments and modified examples do not limit the disclosure according to the claims. It should be noted that not all the combinations of the features described in the embodiments and the modified examples are essential for the solution to the problem adopted by the disclosure.

The disclosure can be implemented with changes made thereto as appropriate within the scope of the gist of the disclosure by omitting or substituting some of the components or adding other components. Further, some of the components of the embodiments and the modified examples described above may be combined.

In the first to fifth embodiments and the modified examples, the case has been described in which the disclosure is applied to a front-and-rear-wheel drive vehicle based on an FR layout with the engine 12 longitudinally mounted. However, the disclosure is not limited to this case, and the engine may be transversely mounted. In this case, the driving force distribution device may be disposed such that the rotational axis of the compound gear (a double gear or a triple gear) extends in the vehicle left-right direction.

What is claimed is:

1. A front-and-rear-wheel drive vehicle including at least an electric motor as a driving source and capable of driving a front wheel and a rear wheel, the front-and-rear-wheel drive vehicle comprising:
a front wheel-side driveshaft configured to transmit a driving force toward the front wheel;
a rear wheel-side driveshaft configured to transmit the driving force toward the rear wheel; and
a driving force distribution device configured to distribute the driving force of the driving source to the front wheel-side driveshaft and the rear wheel-side driveshaft,
wherein the driving force distribution device includes:
a first rotating member;
a second rotating member configured to rotate around a rotational axis parallel to a rotational axis of the first rotating member;
an annular driving force transmission medium configured to transmit the driving force from the first rotating member to the second rotating member; and
a motor driving force-rotated member configured to be rotated by the driving force of the electric motor, and
wherein the motor driving force-rotated member is passed inside the driving force transmission medium, between the first rotating member and the second rotating member.

2. The front-and-rear-wheel drive vehicle according to claim 1, wherein the driving force transmission medium is an annular endless band-shaped body that is wrapped around the first and second rotating members and rotates circularly.

3. The front-and-rear-wheel drive vehicle according to claim 1, wherein:
the driving force distribution device includes a compound gear including a plurality of gears and a coupling shaft that couples the gears together such that the gears rotate integrally; and
the motor driving force-rotated member is the coupling shaft.

4. The front-and-rear-wheel drive vehicle according to claim 3, wherein:
the compound gear includes an input-side gear to which the driving force of the electric motor is transmitted and a plurality of output-side gears, each of the output-side gears having a different pitch diameter;
the input-side gear and the output-side gears are coupled together by the coupling shaft; and
the compound gear is configured to switch from which of the output-side gears the driving force is transmitted toward the front wheel-side driveshaft and toward the rear wheel-side driveshaft.

5. The front-and-rear-wheel drive vehicle according to claim 1, wherein the motor driving force-rotated member is an output rotating shaft of the electric motor.

6. The front-and-rear-wheel drive vehicle according to claim 1, wherein:
the driving force distribution device includes a front wheel-side output rotating shaft to which the front wheel-side driveshaft is coupled, a rear wheel-side output rotating shaft to which the rear wheel-side driveshaft is coupled, and a positive clutch configured to switch between a coupled state and an uncoupled state, the coupled state being a state in which a differential between the front wheel-side output rotating shaft and the rear wheel-side output rotating shaft is restricted, the uncoupled state being a state in which the differential is not restricted; and
the positive clutch is disposed on the same axis as one of the first and second rotating members.

7. The front-and-rear-wheel drive vehicle according to claim 1, wherein:
the driving force distribution device includes a front wheel-side output rotating shaft to which the front wheel-side driveshaft is coupled, a rear wheel-side output rotating shaft to which the rear wheel-side driveshaft is coupled, and a differential gear mechanism configured to distribute the driving force of the driving source toward the front wheel-side output rotating shaft and toward the rear wheel-side output rotating shaft; and
the differential gear mechanism is disposed on the same axis as one of the first and second rotating members.
